(19) United States
(12) Patent Application Publication
(10) Pub. No.: US 2002/0163756 A1
(43) Pub. Date: Nov. 7, 2002

(54) Grooved spindle motor hub wrapped with O-rings for disk centering

(76) Inventors: Shiao-Hua Chen, Palo Alto, CA (US); Tho Pham, Milipitas, CA (US)

Correspondence Address: Ben J. Yorks, IRELL & MANELLA, LLP, Ste 400, 840 Newport Center Drive, Newport Beach, CA, 92660, US

(21) Appl. No.: 09/847,734

(22) Filed: May 1, 2001

(51) Int. Cl. G11B 17/02

(52) U.S. Cl. 360/99.12

(57) ABSTRACT

A spindle motor assembly that includes an elastomer which couples a disk to a motor hub. The elastomer centers the disk with the motor hub. Centering the disk improves the overall balance of the spindle motor assembly.

### BACKGROUND OF THE INVENTION

1. Field of the Invention

The present invention relates to a spindle motor/disk assembly of a hard disk drive.

2. Background Information

Hard disk drives contain a plurality of magnetic heads that are coupled to rotating disks. The heads write and read information by magnetizing and sensing the magnetic fields of the disk surfaces. There have been developed magnetic heads that have a write element for magnetizing the disks and a separate read element for sensing the magnetic fields of the disks. The read element is typically constructed from a magneto-resistive material. The magneto-resistive material has a resistance that varies with the magnetic fields of the disk. Heads with magneto-resistive read elements are commonly referred to as magneto-resistive (MR) heads.

Each head is attached to a flexure arm to create a subassembly commonly referred to as a head gimbal assembly (“HGA”). The HGA's are attached to an actuator arm which has a voice coil motor that can move the heads across the surfaces of the disks.

The disks are rotated by a spindle motor that is mounted to a base plate of the drive. Each disk has a center opening that slides over a hub of the spindle motor. To allow clearance between the disks and spindle motor the inner diameter of the center opening is larger than the outer diameter of the motor hub. The larger center disk opening creates a space between the disks and the hub. The space may allow the disk to be offset from the center of the spindle motor. Offset disks will create an imbalance in the spindle motor/disk assembly.

The imbalance in the spindle motor must be corrected before assembling the motor/disk assembly into a hard disk drive. The spindle motor balancing procedure typically requires the iterative steps of measuring the stability of the motor, and then shifting the positions of the disks, adding weights to the assembly, or some other means to balance the motor. Such procedures are a time consuming process that adds to the cost of mass producing hard disk drives.

### BRIEF SUMMARY OF THE INVENTION

One embodiment of the present invention is a spindle motor assembly that includes an elastomer which couples a disk to a motor hub.

### BRIEF DESCRIPTION OF THE DRAWINGS

FIG. 1 is a top view of an embodiment of a hard disk drive of the present invention;

FIG. 2 is a side sectional view of a spindle motor assembly;

FIG. 3 is a side sectional view showing an alternate embodiment of an O-ring of the spindle motor assembly;

FIG. 4 is a schematic of an electrical system of the hard disk drive.

### DETAILED DESCRIPTION OF THE PREFERRED EMBODIMENT

In general one embodiment of the present invention provides a spindle motor assembly that includes an elastomer which couples a disk to a motor hub. The elastomer centers the disk with the motor hub. Centering the disk improves the overall balance of the spindle motor assembly.

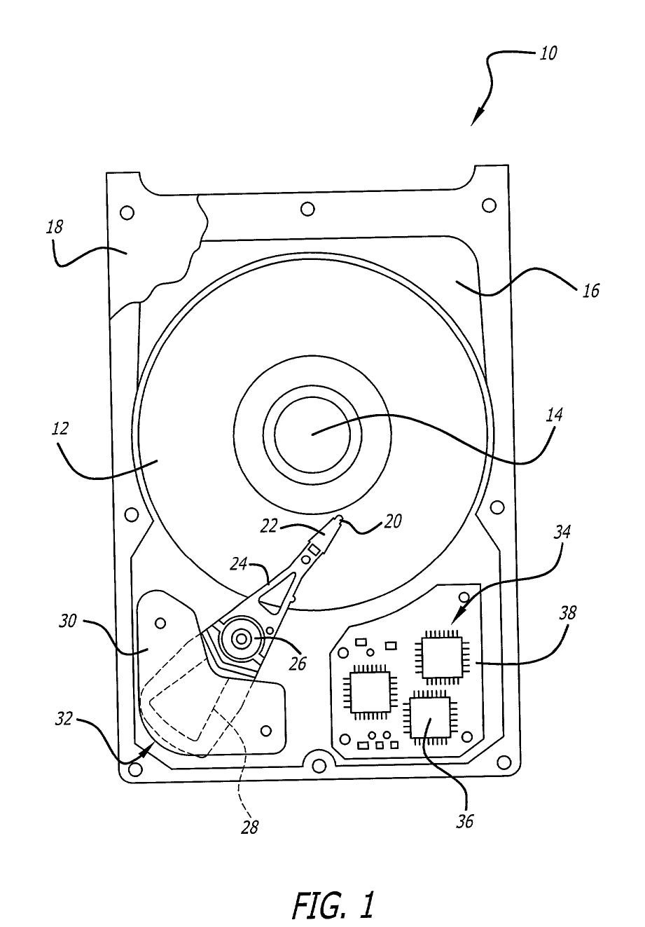

Referring to the drawings more particularly by reference numbers, FIG. 1 shows an embodiment of a hard disk drive 10 of the present invention. The disk drive 10 may include one or more magnetic disks 12 that are rotated by a spindle motor 14. The spindle motor 14 may be mounted to a base plate 16. The disk drive 10 may further have a cover 18 that encloses the disks 12.

The disk drive 10 may include a plurality of heads 20 located adjacent to the disks 12. The heads 20 may have separate write and read elements (not shown) that magnetize and sense the magnetic fields of the disks 12.

Each head 20 may be gimbal mounted to a flexure arm 22 as part of a head gimbal assembly (HGA). The flexure arms 22 are attached to an actuator arm 24 that is pivotally mounted to the base plate 16 by a bearing assembly 26. A voice coil 28 is attached to the actuator arm 24. The voice coil 28 is coupled to a magnet assembly 30 to create a voice coil motor (VCM) 32. Providing a current to the voice coil 28 will create a torque that swings the actuator arm 24 and moves the heads 20 across the disks 12.

The hard disk drive 10 may include a printed circuit board assembly 34 that includes a plurality of integrated circuits 36 coupled to a printed circuit board 38. The printed circuit board 36 is coupled to the voice coil 28, heads 20 and spindle motor 14 by wires (not shown).

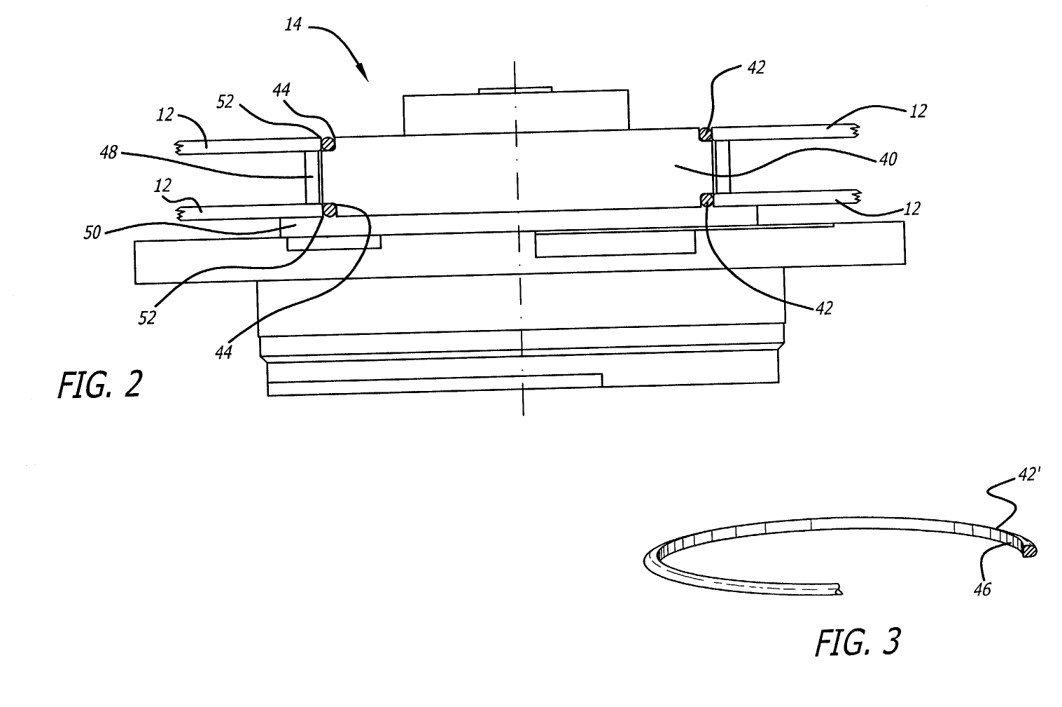

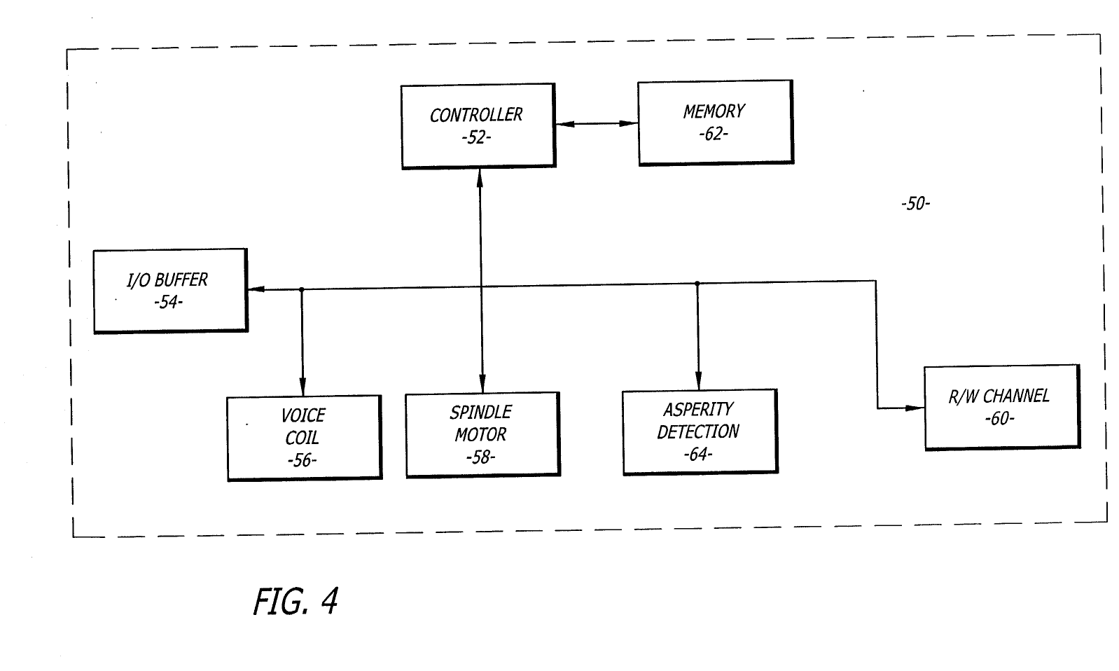

FIG. 2 shows an embodiment of the present invention wherein the disks 12 are coupled to a hub 40 of the spindle motor 14 by elastomers 42. By way of example, the elastomers 42 may be O-rings located within corresponding grooves 44 of the motor hub 40. Tho O-rings may be circular shaped as shown in FIG. 2, or D-shaped elastomers 42′ as shown in FIG. 3. The D-shaped O-rings 42′ have a flat surface 46 that conforms with the flat surface of the hub groove 44.

The disks 12 may be separated by a spacer 48. Additionally, the disks 12 and spacer 48 may be pressed into a lower collar 50 of the hub 40 by a clamp (not shown). Although not shown, the spindle motor/disk assembly may also include an elastomer located between the spacer 48 and the hub 40.

The disks 12 can be assembled onto the spindle motor 14 by initially placing the elastomeric O-rings 42 into the hub grooves 44. The dimensions of the O-rings 42 and grooves 44 may be such that the elastomeric material is under tension. The tension will create an inward force that will retain the O-rings 42 within the grooves 44.

The disks 12 may then be assembled onto the spindle motor 14 by sliding the hub 40 through the disk center openings 52. The dimensions of the center openings 52 may be such that the disks 12 squeeze and deflect the O-rings 42. The deflection will create a pressure that will reduce the relative movement between the disks 12 and the spindle motor 14. This will improve the dynamic balance of the spindle motor/disk assembly. Additionally, the O-rings 42 center the disks 12 onto the spindle motor 14, thereby improving both the static and dynamic balance of the spindle motor/disk assembly.

FIG. 3 shows a schematic of an electrical system 50 that can control the disk drive 10. The system 50 includes a controller 52 that is connected to an input/output (I/O) buffer 54, voice coil motor control circuit 56, spindle motor control circuit 58, read/write channel circuit 60, memory 62. The I/O buffer 54 provides an interface with an external source such as a personal computer. The voice coil control circuit 56 and spindle motor control circuit 58 contain drivers, etc. to control the voice coil motor and spindle motor, respectively.

The voice coil motor circuit 56 and spindle motor control circuit 58 operate in accordance with signals, commands, etc. from the controller. The controller 52 may be a processor that can perform software routines in accordance with instructions and data to operate the storage and retrieval of information from the disks 12.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

What is claimed is:

1. A spindle motor assembly for a hard disk drive, comprising:
a motor hub;
a disk; and,
an elastomer that couples said disk to said motor hub.

2. The assembly of claim 1, wherein said elastomer is an O-ring.

3. The assembly of claim 1, wherein said elastomer is located within a groove of said motor hub.

4. The assembly of claim 1, wherein said elastomer is located between said motor hub and said disk.

5. The assembly of claim 2, wherein said O-ring is circular shaped.

6. The assembly of claim 2, wherein said O-ring is D shaped.

7. A hard disk drive, comprising:
a base plate;
a spindle motor attached to said base plate;
a disk;
an elastomer that couples said disk to said spindle motor;
an actuator arm attached to said base plate;
a head attached to said actuator arm and coupled to said disk;
a voice coil motor attached to said actuator arm.

8. The hard disk drive of claim 7, wherein said elastomer is an O-ring.

9. The hard disk drive of claim 7, wherein said elastomer is located within a groove of said motor hub.

10. The hard disk drive of claim 7, wherein said elastomer is located between said motor hub and said disk.

11. The hard disk drive of claim 8, wherein said O-ring is circular shaped.

12. The hard disk drive of claim 8, wherein said O-ring is D shaped.

13. A method for assembling a spindle motor assembly of a hard disk drive, comprising:
attaching an elastomer to a motor hub; and,
attaching a disk to the elastomer.

14. The method of claim 13, wherein the elastomer is placed into a groove of the motor hub.

15. A spindle motor assembly for a hard disk drive, comprising:
a motor hub;
a disk coupled to said motor hub; and,
an elastomer located between said disk and said motor hub.

16. The assembly of claim 15, wherein said elastomer is an O-ring.

17. The assembly of claim 15, wherein said elastomer is located within a groove of said motor hub.

18. The assembly of claim 16, wherein said O-ring is circular shaped.

19. The assembly of claim 16, wherein said O-ring is D shaped.
